(19) United States
(12) Patent Application Publication
(10) Pub. No.: US 2008/0292333 A1
(43) Pub. Date: Nov. 27, 2008

(54) IMAGE FORMING APPARATUS

(75) Inventor: Katsuyuki Yamazaki, Toride-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/123,577

(22) Filed: May 20, 2008

(30) Foreign Application Priority Data
May 21, 2007 (JP) 2007-134580
May 12, 2008 (JP) 2008-124973

(51) Int. Cl. G03G 15/08

(52) U.S. Cl. 399/27

(57) ABSTRACT

An image forming apparatus that forms a latent image on an image carrier based on image data, the apparatus includes: a first calculating unit adapted to calculate an exposure amount of a pixel of interest included in a partial region configured of a plurality of pixels that constitute the image data; a second calculating unit adapted to calculate an exposure amount of surrounding pixels that are located around the pixel of interest and constitute the partial region; and a toner consumption amount calculating unit adapted to calculate a toner consumption amount of the pixel of interest based on the exposure amount of the pixel of interest and the exposure amount of the surrounding pixels, wherein the second calculating unit calculates the exposure amount of the pixel of interest by weighting the image data corresponding to the surrounding pixels on a pixel-by-pixel basis.

### BACKGROUND OF THE INVENTION

1. Field of the Invention

The present invention relates to an image forming technique.

2. Description of the Related Art

In recent years, as printers become advanced in functionality, and provide higher quality images at a higher speed, there is an increased demand for the reduction of the cost of the printers themselves and the consumable items used in image formation, such as toner. To satisfy such demand, proposals have been made to reduce wasted toner, shorten the adjustment time of electrophotographic systems, and suppress the running cost by efficiently controlling the use of image forming materials (developing materials) such as toner (e.g., Japanese Patent Laid-Open Nos. 06-138769, 2002-189385, 06-11969, 06-175500, 2003-122205, and 10-239980).

As a method for detecting the amount of toner consumed, there is a method called “video count”. Video count is a method for estimating the amount of the image forming material consumed when producing an image, by adding/cumulating image data to be produced using a printer or digital copying machine, or the driving time of a writing device (e.g., the laser emission time of a laser printer's exposure unit). In other words, the amount of toner consumed is estimated through addition/cumulation by counting the number of dot pixels written onto a photosensitive member.

A conventional video count method shall now be described. When handling image data in bitmap format, a coat of a memory is required if all the bitmap information is to be held (stored) in a memory or the like. Accordingly, digital image forming apparatuses generally handle data as video streams, which are easily processed on a pixel-by-pixel basis.

The video count method generally involves real-time addition/cumulation of the video streams when forming an image. However, it is often the case that the added/cumulated value (video count value) is not directly proportional to the amount of toner that is actually consumed. The reason is because the pixels cannot be approximated accurately to a rectangular shape. FIG. 7 is a schematic diagram illustrating the potential of a linear latent image in the main scanning direction on a photosensitive drum of a conventional laser scanner. As shown in 7a to 7e of FIG. 7, a substantially circular exposure spot extends beyond a rectangular pixel, resulting in escaping light (leaking light).

For example, in the stages shown in 7a to 7e of FIG. 7, the influence of the leaking light cannot be ignored when calculating a change in the leaking light and exposure condition and the amount of toner consumed based on that change.

In an electrophotographic image forming apparatus, a single dot (a single pixel) written onto the photosensitive member is influenced heavily by the dots adjacent thereto. For this reason, the amount of toner fixed to a single dot (pixel) that is written varies depending on whether the adjacent pixels are white or black (i.e., whether the single dot (pixel) is surrounded by white data or black data).

Accordingly, the method in which a single pixel is counted as one without considering the state of the adjacent pixels has a problem in that a significant margin or error occurs over time because of such addition/cumulation, and an accurate estimation of the amount of toner remaining or the amount of toner consumed cannot be achieved using the video count value. In order to eliminate the disparity between the video count value and the amount of toner consumed, a proposal has been made to correct the number of pixels of interest using the write information of the adjacent pixels; specifically, when performing a video count taking the center pixel of a 3×3 matrix as the pixel of interest, a correction is made by the number of pixels that are written among the adjacent eight pixels surrounding the pixel of interest (for example, Japanese Patent Laid-Open No. 2006-195246).

However, according to the video count method of Japanese Patent Laid-Open No. 2006-195246, the number of pixels of interest is corrected only by the write information of the pixels that are adjacent to the pixel of interest. Accordingly, this method has a problem in that the relationship between the video count value and the actual amount of toner consumed is insufficient, and a margin of error is left between the resulting video count value and the actual amount of toner consumed. The reason why a margin of error is left between the resulting video count value and the actual amount of toner consumed can be considered as follows.

That is, the reason is that the cumulated number of pixels and the cumulated exposure amount are regarded as similar. In other words, when cumulating the number of adjacent pixels in a binary value, it is assumed that the pixels located to the right, left, top, and bottom of the pixel of interest and the pixels located diagonally to the pixel of interest have the same “weight”. The degree of influence exerted on the pixel of interest varies according to the position (distance) of the adjacent pixels. This is because a difference in distance occurs by a rate of √2, even in the center of the pixel. Further, the pixel of interest is also influenced by the pixels that are not adjacent to the pixel of interest but are located in the periphery of the pixel of interest, with the degree of influence varying according to the distance therefrom, similar to that of the adjacent pixels. It is therefore necessary to take this into consideration.

It is important to take such a margin of error into consideration to maintain the accuracy of the video count.

### SUMMARY OF THE INVENTION

In view of the problems encountered with the conventional technology described above, it is an object of the present invention to provide an image forming technique with which the amount of an image forming material (toner) consumed can be calculated with high accuracy.

Alternatively, it is an object of the present invention to provide an image forming technique with which it is possible to accurately detect the state of the image forming apparatus based on the calculated amount of consumed toner, and make a notification regarding the timing of maintenance.

Alternatively, it is an object of the present invention to provide an image forming technique with which it is possible to make a notification regarding the timing of toner supply based on the calculated amount of consumed toner, and reduce unnecessary toner supply and wasted toner.

According to one aspect of the present invention, there is provided an image forming apparatus that forms a latent image on an image carrier based on image data, the apparatus comprising: a first calculating unit adapted to calculate an exposure amount of a pixel of interest included in a partial region configured of a plurality of pixels that constitute the image data; a second calculating unit adapted to calculate an exposure amount of surrounding pixels that are located around the pixel of interest and constitute the partial region; and a toner consumption amount calculating unit adapted to calculate a toner consumption amount of the pixel of interest based on the exposure amount of the pixel of interest and the exposure amount of the surrounding pixels, wherein the second calculating unit calculates the exposure amount of the pixel of interest by weighting the image data corresponding to the surrounding pixels on a pixel-by-pixel basis.

According to the present invention, it is possible to calculate the amount of consumed image forming material (toner) with high accuracy.

Alternatively, it is possible to accurately detect the state of the image forming apparatus based on the calculated amount of consumed toner, and make a notification regarding the timing of an image adjustment.

Alternatively, it is possible to make a notification regarding the timing of toner supply based on the calculated amount of toner consumption, thereby reducing unnecessary toner supply and wasted toner.

Further features of the present invention will become apparent from the following description of exemplary embodiments with reference to the attached drawings.

### BRIEF DESCRIPTION OF THE DRAWINGS

FIG. 1 is a diagram illustrating a schematic configuration of an electrophotographic image forming apparatus provided with a laser scanner according to an embodiment of the present invention.

FIG. 2A is a flowchart illustrating a process flow of a self-adjustment sequence.

FIG. 2B is a diagram illustrating a measurement pattern formed during a self-adjustment sequence.

FIG. 3 is an enlarged view of an internal circuit of a video count unit 160.

FIG. 4A is a graph illustrating a relationship between the distance (pixel) from the center of the laser spot of a given pixel of interest and the amount of exposure on the surface of a photosensitive drum.

FIG. 4B is a graph illustrating toner consumption amount characteristics (profiles) and an exposure intensity (exposure amount) gradually changed in a self-adjustment sequence.

FIG. 5A is a graph illustrating an exemplary distribution of weighting data held in the weighting data holding unit 320 based on the exposure amount profile of FIG. 4A.

FIG. 5B is a table illustrating exemplary weighting data of blocks located in a plane defined by the main scanning direction (x) and the sub-scanning direction (y).

FIG. 6 is a diagram illustrating an exemplary distribution of amount of exposure of pixels.

FIG. 7 is a schematic diagram illustrating the potential of a linear latent image in the main scanning direction on a photosensitive drum of a conventional laser scanner.

### DESCRIPTION OF THE EMBODIMENTS

Hereinafter, preferred embodiments of the present invention shall be described with reference to the accompanying drawings. However, it should be noted that the constituent elements described in these embodiments are merely exemplary, and the technical scope of the present invention is defined by the appended claims, rather than by the individual embodiments described below.

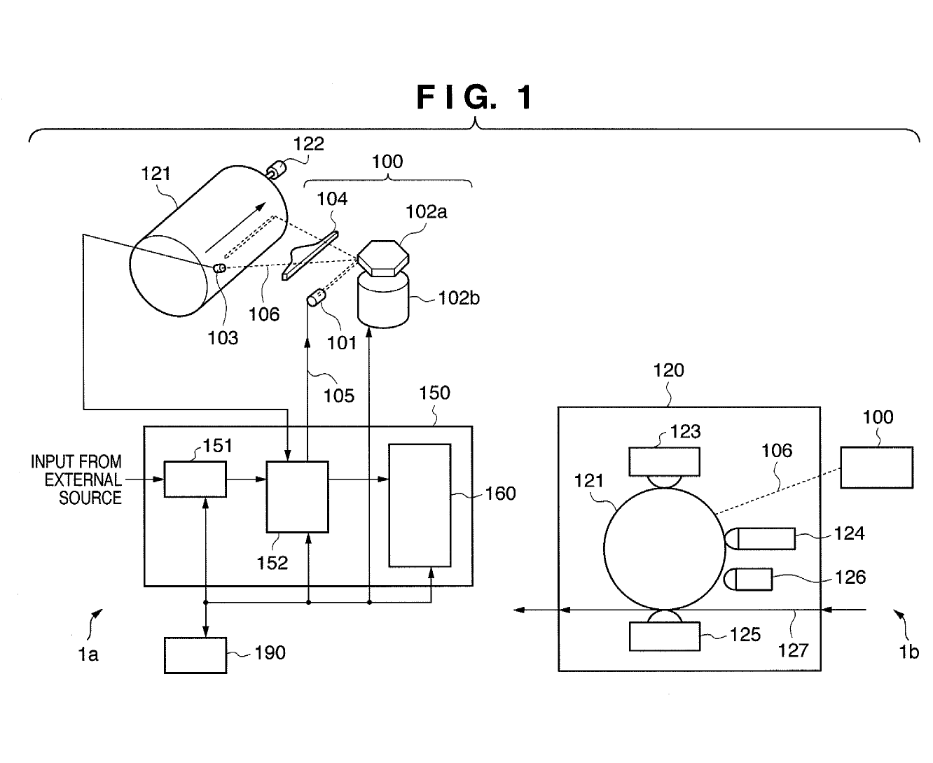

FIG. 1 is a diagram illustrating a schematic configuration of an electrophotographic image forming apparatus provided with a laser scanner according to an embodiment of the present invention. A semiconductor laser device 101 shown in 1a of FIG. 1 irradiates a laser beam based on a control signal 105 that controls the laser emission. A polygon mirror 102a reflects the laser beam irradiated by the semiconductor laser device 101, and irradiates the laser beam to a photosensitive drum 121, which is an image carrier, through an fθ lens 104. A polygon mirror driving apparatus 102b can control the rotational drive of the polygon mirror 102a. The fθ lens 104 is a lens that converts the laser beam such that the laser beam is scanned in the direction (also referred to as “main scanning direction”) orthogonal to the rotating direction (also referred to as “sub-scanning direction”) of the photosensitive drum (image carrier) 121 at a constant velocity.

A photosensor 103 is disposed in a laser beam path 106, and can detect the scanning start of the laser beam in the main scanning direction.

The semiconductor laser device 101, the polygon mirror 102a, the driving apparatus 102b, the photosensor 103, the fθ lens 104, the control signal 105, and the laser beam path 106 together form a laser beam scanner 100.

As shown in 1b of FIG. 1, the laser beam scanner 100 irradiates a laser beam onto the photosensitive drum 121. The surface of the photosensitive drum 121 is charged to a predetermined potential by a photosensitive drum charger 123. An electrostatic latent image is formed on the charged surface of the photosensitive drum by the irradiation of the laser beam. The photosensitive drum 121 can be rotatively driven under control of a driving apparatus 122. A developing unit 124 bonds an image forming material (toner) onto the electrostatic latent image of the photosensitive drum 121, forming a toner image. A toner density detecting sensor 126 measures the density of the toner image on the photosensitive drum 121. A recording medium such as paper is fed through a conveying path 127. A transfer unit 125 transfers the toner image on the photosensitive drum 121 onto the recording medium.

The photosensitive drum 121, the driving apparatus 122, the photosensitive drum charger 123, the developing unit 124, the transfer unit 125, the toner density detecting sensor 126, and the conveying path 127 together form a toner image forming unit 120.

An image data holding unit 151 receives an input of image data from an external source and holds the data. A density converting unit 152 converts the density of the image data received from the image data holding unit 151 to a laser emission amount using a density conversion table to produce emission amount data. The density converting unit 152 outputs the produced emission amount data to the semiconductor laser device 101 in the form of control signal 105 that controls the laser emission. Reference numeral 160 denotes a video count unit. The image data holding unit 151, the density converting unit 152, and the video count unit 160 together form an image processing unit 150.

A system control unit 190 controls the entire image forming apparatus. The laser beam scanner 100, the toner image forming unit 120, and the image processing unit 150 can be operated in conjunction with each other in accordance with instructions from the system control unit 190.

The image processing unit 150 receives various image data from an information processing apparatus connected to the image forming apparatus.

The image processing unit 150 produces data (emission amount data) for providing a laser emission amount necessary for forming an image based on the received image data, and outputs the produced data in the form of control signal 105, which controls the laser emission, to the laser beam scanner 100. The semiconductor laser device 101 of the laser beam scanner 100 irradiates a laser beam based on the control signal 105. The beam is scanned on the photosensitive drum 121, and an electrostatic latent image is formed. The toner image forming unit 120 develops the electrostatic latent image with toner.

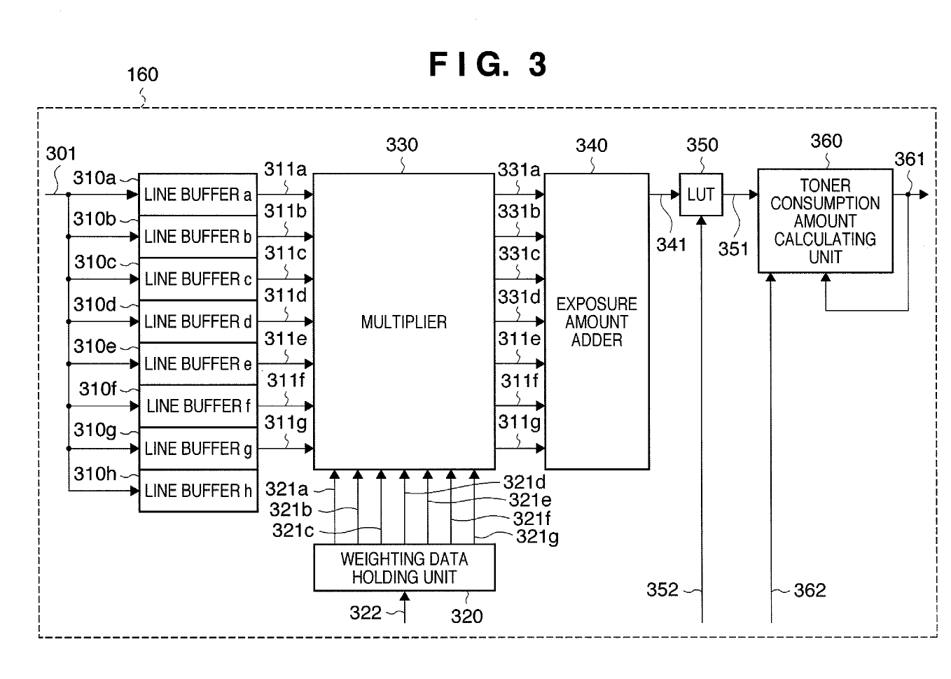

The video count unit 160 shall be described in detail next. FIG. 3 is an enlarged view of an internal circuit of the video count unit 160.

Reference numeral 301 denotes a video input signal (video stream), which is image data corresponding to a laser emission pattern. When forming an image, the video stream 301 is input to the video count unit 160.

Reference numerals 310a to 310h denote line buffers (storage units) that store data of a plurality of scan lines corresponding to the main scanning direction along which the laser is irradiated. The eight line buffers correspond to eight scans performed by the laser beam scanner 100. The line buffers 310a to 310h are switched in sequence by a line synchronizing signal (not shown), and image data is written into the eight line buffers in sequence. When the writing of image data into the eight line buffers 310a to 310h is finished, the first written line buffer is overwritten with the image data of the ninth line. In this manner, the writing operation is performed for the tenth line, the eleventh line, and so on until the end of the video stream 301 is processed. Herein, it is assumed that the video stream 301 is blank for seven lines at its head and tail, and each line contains seven pixels' worth of blank data that correspond to the right and left ends of an image (see FIG. 6).

Reference numerals 311a to 311g denote output data that are output from the line buffers 310a to 310g. Seven scans' worth of image data scanned by the laser beam scanner 100 is inputted with seven pixels for a single scan (i.e., 49 pixels' worth of data in total, the number of pixels constituting a partial region) to a multiplier 330 where the data is stored. The line buffers are switched in sequence, and the data outputted from the line buffers is input to the multiplier 330.

When the data is written into the line buffers for seven lines including the blank, the video count unit 160 starts the calculation of an effective video count.

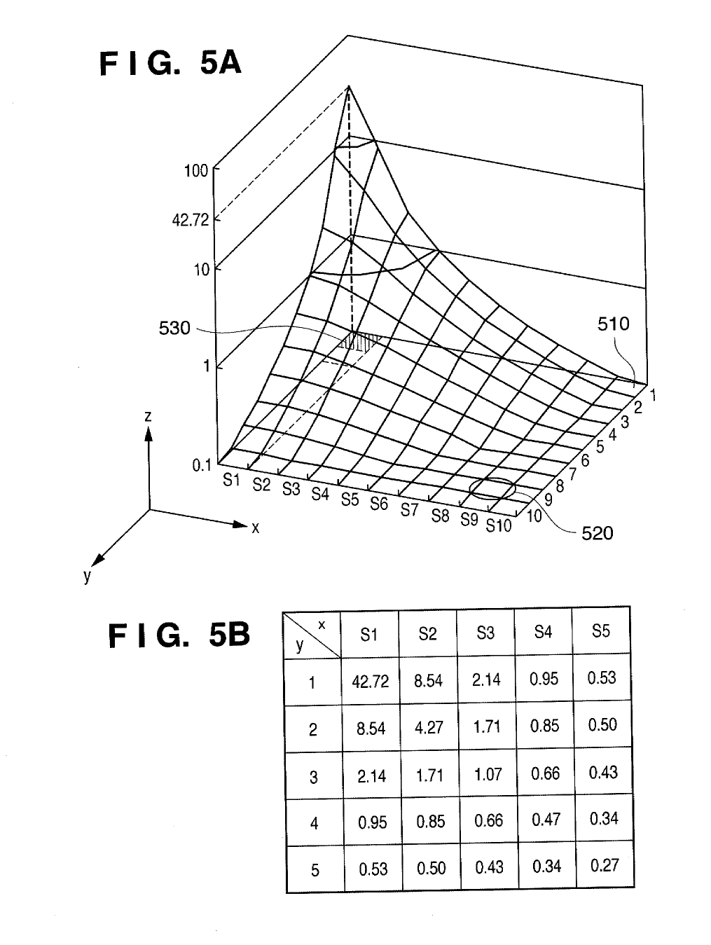

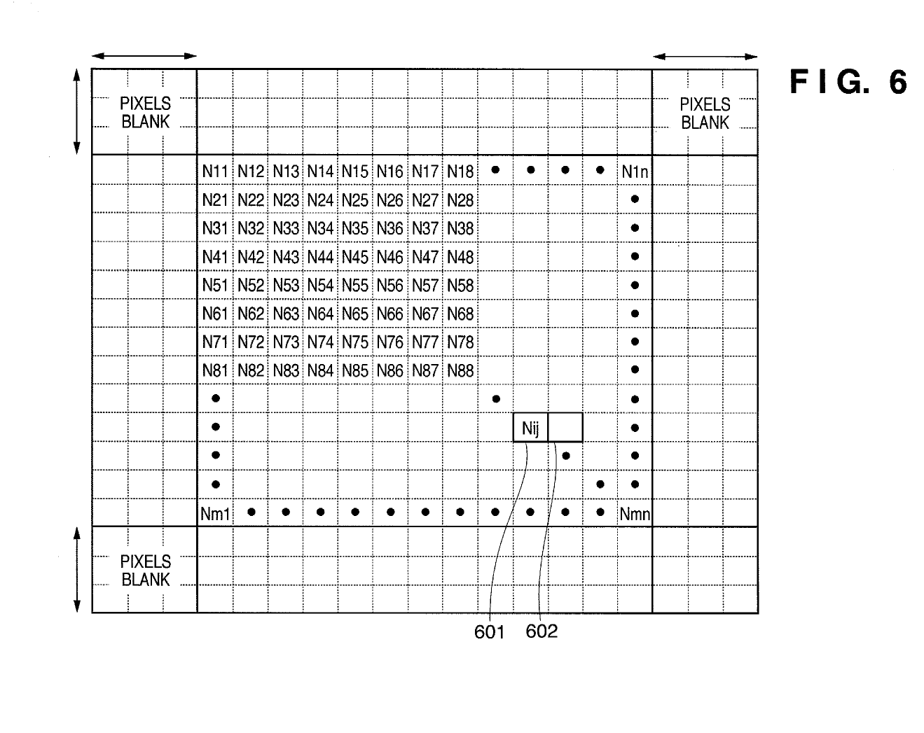

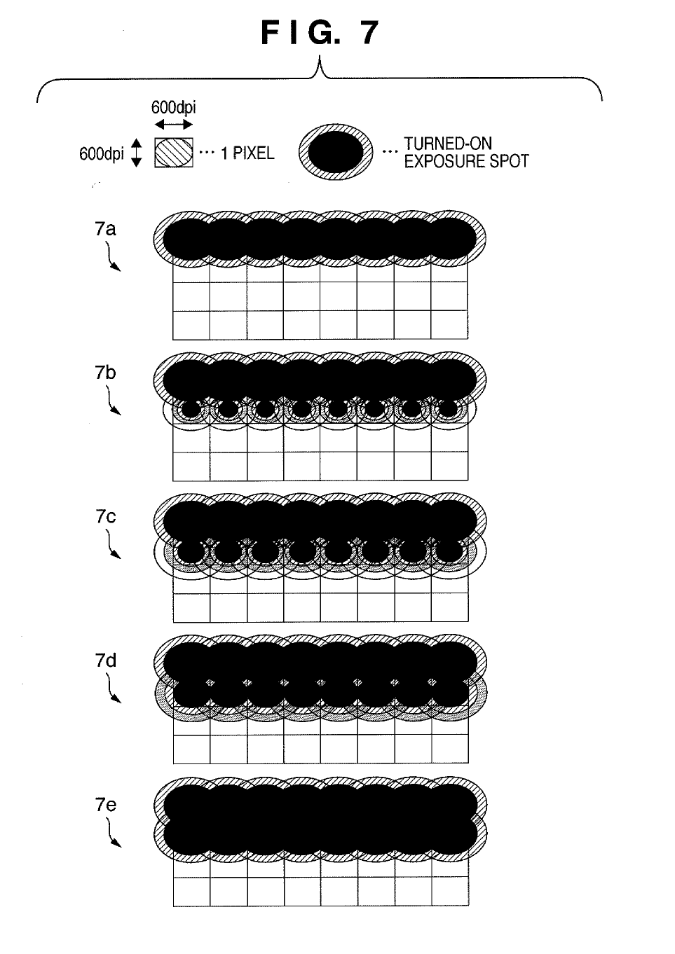

Reference numeral 320 denotes a weighting data holding unit that holds weighting data weighted based on the distance (pixel distance) to a pixel of interest. A signal 322 is a signal for inputting weighting data from the system control unit 190 to the weighting data holding unit 320. A coefficient value calculated based on a laser spot profile obtained from a laser scanner optical system (e.g., numerical values shown in FIG. 5B) is inputted to the weighting data holding unit 320.

The weighting data holding unit 320 (holding unit) can output the output signals 321a to 321g of the weighting data to the multiplier 330 in synchronization with the start of the calculation of the video count.

The multiplier 330 defines one pixel in the image data of the fourth line, which is the center of the seven lines, as a pixel of interest, and performs a multiplication to obtain the output data of the line buffers (exposure amount) and weighting data for the pixel of interest and 48 surrounding pixels.

The multiplier 330 defines the resulting weighting data of the pixel of interest included in the partial region that constitutes a page as center pixel exposure amount data. In this case, the multiplier 330 functions as a first calculating unit. The multiplier 330 performs a multiplication to obtain weighting data corresponding to each pixel distance for the 48 surrounding pixels that are located around the pixel of interest and constitute the partial region. Then, the multiplier 330 defines the obtained result as surrounding pixel exposure amount data. In this case, the multiplier 330 functions as a second calculating unit.

The multiplier 330 then outputs, to an exposure amount adder 340 (third calculating unit), output signals (partial exposure amount data 331a to 331g) indicative of the result of the multiplication of the total of 49 pixels, that is, the center pixel exposure amount data and the surrounding pixel exposure amount data of the 48 pixels.

The exposure amount adder 340 adds the output signals (partial exposure amount data 331a to 331g) indicative of the result of the multiplication output from the multiplier 330. The exposure amount adder 340 (third calculating unit) outputs the result of the addition as total exposure amount data 341 of the pixel of interest.

A conversion lookup table (LUT) 350 (converting unit) converts the total exposure amount data 341 of the pixel of interest output from the exposure amount adder 340 to data indicative of the amount of toner consumption per pixel (pixel toner consumption amount data) according to the LUT data, and outputs the pixel toner consumption amount data 351.

As used herein, the LUT data is a conversion coefficient for converting the amount of exposure to the amount of toner consumption. A signal 352 is a signal that is transmitted from the system control unit 190 and used to input the LUT data into the conversion lookup table (LUT) 350. A conversion coefficient for converting the exposure amount obtained through a self-adjustment sequence, which shall be described later, to an amount of toner consumption is input to the conversion lookup table (LUT) 350.

The pixel toner consumption amount data 351 converted by the conversion lookup table (LUT) 350 is input to a toner consumption amount calculating unit 360. The toner consumption amount calculating unit 360 can calculate the amount of toner consumption per page, and is initialized upon receiving a control signal 362 that is transmitted from the system control unit 190. This initialization clears the data of the amount of toner consumption per page to zero.

The toner consumption amount calculating unit 360 can cumulate the pixel toner consumption amount data 351 one after another for the effective region excluding the blank region and the like.

The process described above is performed by changing the pixel of interest, and the toner consumption amount calculating unit 360 cumulates the pixel toner consumption amount data 351 one after another to eventually calculate an amount of toner consumption per page 361, and outputs the amount of toner consumption per page 361.

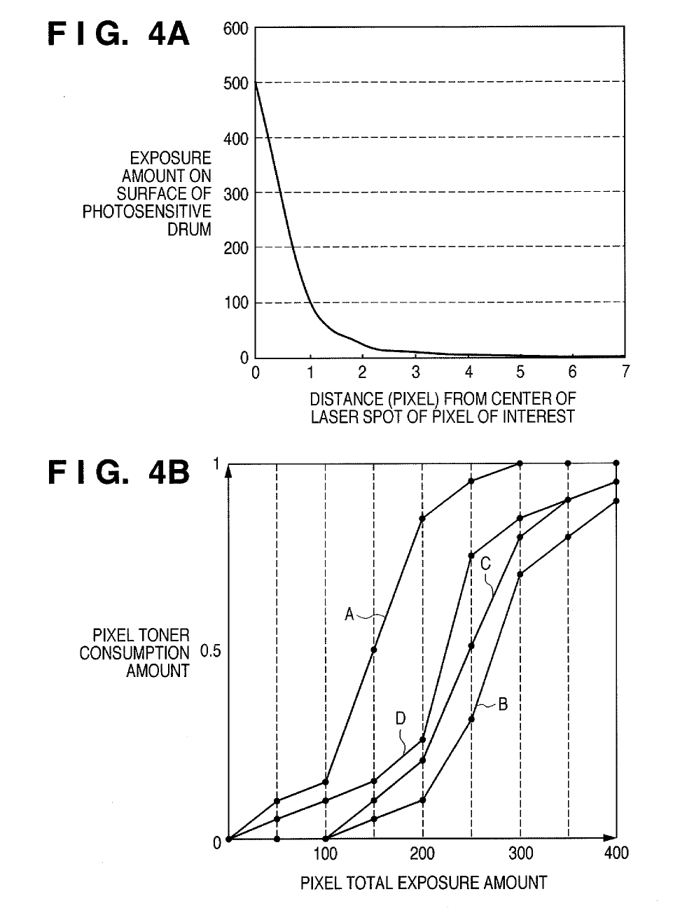

The physical background as to why the number of pixels in the partial region that constitutes a page is set to seven pixels by seven pixels shall be described hereinafter. FIG. 4A is a graph illustrating a relationship (exposure amount profile) between the distance (pixel) from the center of the laser spot of a given pixel of interest and the amount of exposure on the surface of a photosensitive drum.

The laser spot has a spot shape of a substantially perfect circle, and has an optical intensity sufficient to form a single pixel. It is known from optical designing and numerical values that there is leaking light in the distance (position) two pixels away, three pixels away, and so on, from a given pixel of interest. The distribution of the amount of exposure is symmetric with respect to the pixel of interest.

If the target accuracy is set to a margin of error of about 1% relative to the total amount of exposure, in the case of FIG. 4A, it is sufficient to consider the distribution of the amount of exposure to the distance three pixels away from a pixel of interest (0). As for the distance four or more pixels away from the pixel of interest (0), the calculation of the amount of exposure is not necessary. In the present embodiment, the video count unit 160 calculates the total amount of exposure for a rectangular region (seven pixels by seven pixels) that secures tree pixels in the right, left, upper and lower directions relative to the pixel of interest (0). The video count unit 160 can set the size of the rectangular region to n pixels by n pixels, or n pixels by m pixels (where n and m are natural numbers) according to the target accuracy relative to the total amount of exposure.

FIG. 5A is a graph illustrating an exemplary distribution of weighting data stored in the weighting data holding unit 320 based on the exposure amount profile of FIG. 4A. In FIG. 5A, the x direction corresponds to the main scanning direction along which the laser beam is scanned on the photosensitive drum 121. The y direction corresponds to the sub-scanning direction corresponding to the rotating direction of the photosensitive drum 121. The z direction indicates weighting data of the pixels located in a plane defined by the main scanning direction (x) and the sub-scanning direction (y).

A block 510 indicates a pixel of image data. In FIG. 5A, the weighting data of a block 530 is 42.7. The unit of the weighting data is indicated as a relative value in the calculation process, and is made dimensionless. FIG. 5B is a table illustrating exemplary weighting data of the blocks located in a plane defined by the main scanning direction (x) and the sub-scanning direction (y).

A single block corresponds to a substantially circular laser spot 520 that is converted onto the photosensitive drum 121 by the laser beam scanner 100 (FIG. 5A). Because overlapping of a plurality of partial exposure amounts corresponds linearly to a change in the amount of charge on the photosensitive drum 121, an addition algorithm can be used to determine the total amount of exposure.

As used herein, the weighting data H can be expressed by the following formula (1), where the function that indicates a weighting amount calculating LUT is represented by f, the position of a pixel of interest is represented by (x0,y0), and the position of the pixel of the calculated coefficient is represented by (x,y). Note that the weighting coefficient can be set asymmetrically in terms of the distances of the main scanning direction and the sub-scanning direction according to the shape of the laser spot, which is a flat circular shape or the like.

H=f(x−x0,y−y0) (1)

In the case of the pixel of interest being located at (S1, 1), for example, f(0,0)=42.72 (FIG. 5B).

FIG. 6 is a diagram illustrating an exemplary distribution of the amount of exposure of the pixels of image data. In the numerical value (Nij) of a block, the exposure amount data is set as data of a two-dimensional array. For example, the partial exposure amount data of a pixel of interest 601 is expressed by the formula (2) using the weighting data shown in FIG. 5B and the exposure amount data.

$${\sum }_{i = 1}^{7} [ {\sum }_{j = 1}^{7} \{ N i j \times f ( i - 4 , j - 4 ) \} ] \qquad ( 2 )$$

When the pixel of interest (Nij) is changed to the adjacent pixel 602 located on the right, the partial exposure amount data is calculated by the formula (3).

$${\sum }_{i = 2}^{8} [ {\sum }_{j = 1}^{7} \{ N i j \times f ( i - 5 , j - 4 ) \} ] \qquad ( 3 )$$

The calculation as described above is performed for other pixels of interest, whereby the partial exposure amount data can be calculated. By changing the pixel of interest, and adding the partial exposure data amount calculated for each pixel of interest one after another, the amount of consumption of an image forming material (toner) per page can be calculated.

A method for determining the conversion profile (conversion coefficient) of the conversion lookup table (LUT) 350 shall be described next.

The image forming apparatus according to the present embodiment can execute a self-adjustment sequence for finely adjusting (controlling) the operation of the laser beam scanner 100 and the toner image forming unit 120. The system control unit 190 starts the self-adjustment sequence according to the operating conditions such as a change in the surrounding environment in which the image forming apparatus is installed, a continuous operation, and suspend time (e.g., power off time). The system control unit 190 can execute the self-adjustment sequence, for example, in the interval between image forming jobs (i.e., after the completion of a first image forming job, and before the start of a second image forming job), at the start-up of the image forming apparatus, or the like. The conversion profile (conversion coefficient) is determined based on the self-adjustment sequence.

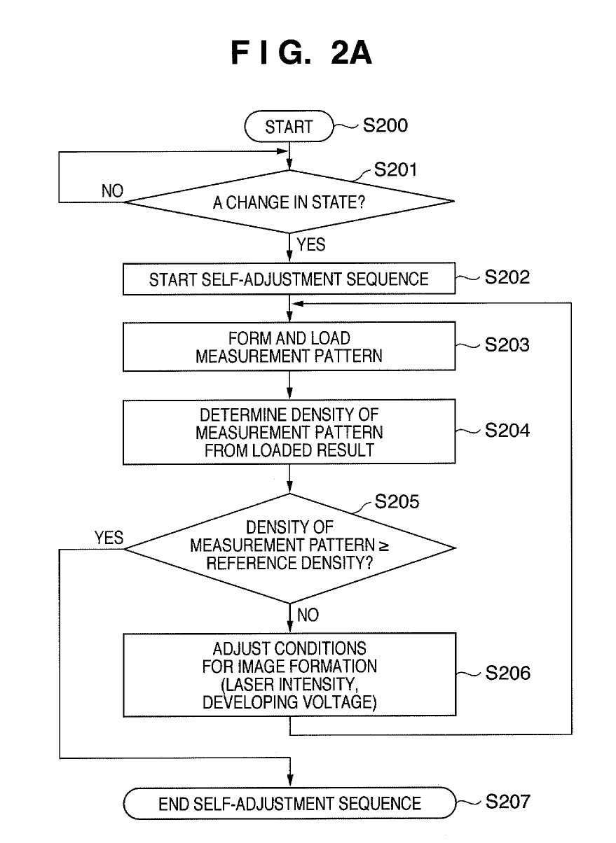

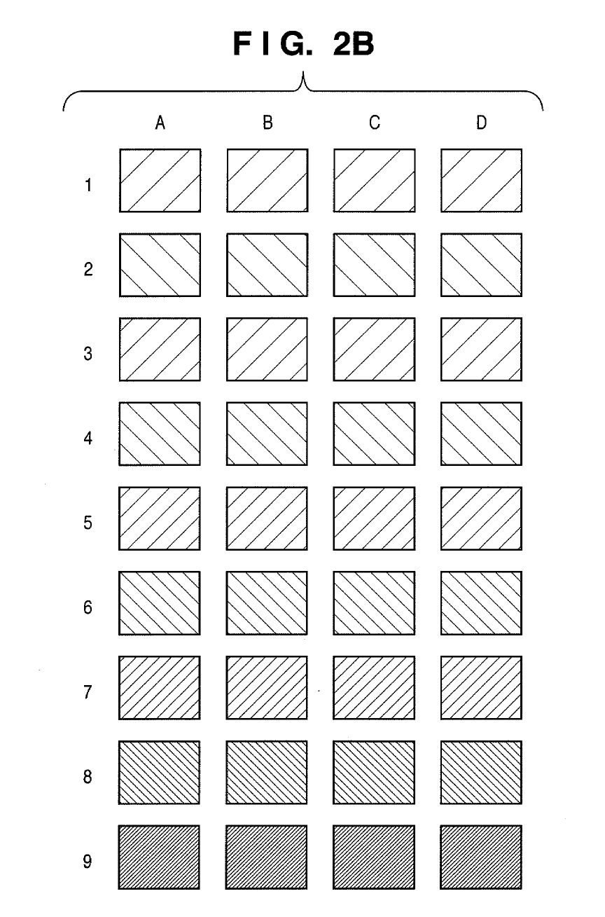

FIG. 2A is a flowchart illustrating the process flow of the self-adjustment sequence.

In step S201, the system control unit 190 determines whether or not there is a change in the state of the image forming apparatus. As described earlier, the “change in the state” is determined based on the operation conditions such as a change in the surrounding environment, a continuous operation, and suspend time. If no change occurs in the state of the image forming apparatus, the system control unit 190 stands by while monitoring the occurrence of a change in the state, without performing the self-adjustment sequence.

If it is determined in step S201 that there is a change in the state (Yes in S201), the process advances to step S202, and the self-adjustment sequence starts.

In step S203, the system control unit 190 causes the toner image forming unit 120 to form a measurement pattern, and loads the measurement pattern using the toner density detecting sensor 126. In step S204, the system control unit 190 determines the density of the measurement pattern based on the loaded result.

In step S205, the system control unit 190 compares the density of the measurement pattern against a predetermined reference density. If the density of the measurement pattern is equal to or greater than the reference density (Yes in S205), the self-adjustment sequence ends (S207).

If it is determined in step S205 that the density of the measurement pattern is less than the reference density (No in S205), the process advances to step S206.

In step S206, the system control unit 190 adjusts the image forming conditions such that the conditions for the reference density are satisfied by, for example, controlling the control signal 105 to increase the intensity of the laser irradiated from the semiconductor laser device 101, to increase the developing high voltage or the like.

Then, the process returns to step S203, and the same process is repeated. If the density of a newly formed measurement pattern exceeds the reference density (Yes in S206), the self-adjustment sequence ends.

FIG. 2B is a diagram illustrating an exemplary measurement pattern formed in the self-adjustment sequence. The measurement pattern is formed by irradiating a pulse width modulated (PWM) laser by gradually changing the laser emission time (DUTY). The measurement pattern is formed in a shape and at a position that can be detected by the toner density detecting sensor 126. Based on the result of the detection of the toner density detecting sensor 126, the intensity of the laser beam irradiated from the semiconductor laser device 101 and the amount of exposure, as well as the amount of charge necessary for the adjustment of the toner image forming unit 120, the developing high voltage (developing bias) and the like are adjusted by the system control unit 190.

The system control unit 190 calculates a conversion coefficient for converting the amount of exposure to the amount of toner consumption based on the exposure intensity (amount of exposure) of the laser used for image formation and the toner density detected by the toner density detecting sensor 126.

FIG. 4B is a graph illustrating toner consumption amount characteristics (profiles) and the exposure intensity (exposure amount) gradually changed in the self-adjustment sequence, in which four different exemplary profiles A, B, C and D obtained by changing the conditions are shown. The horizontal axis represents pixel total exposure amount (exposure amount), and the vertical axis represents pixel toner consumption amount. All the units are made dimensionless and shown in relative values in the calculation process.

The amount of exposure of the photosensitive drum 121 is proportional to the amount of toner consumption as an amount of charge on the photosensitive drum 121, but because there are upper and lower limits on the amount of charge on the surface of the photosensitive drum, the minimum saturation amount of toner consumption and the maximum saturation amount of toner consumption are determined per pixel regardless of the amount of exposure. Accordingly, in each profile, the amount of toner consumption is nearly flat around the upper and lower limits.

The system control unit 190 can select a profile suitable for exposure conditions from the profiles of FIG. 4B, and calculate a conversion coefficient for converting the amount of exposure to the amount of toner consumption. In this case, as for the data of the points except for the points used to measure the measurement pattern, the system control unit 190 can perform an interpolation calculation based on the profiles of FIG. 4B to obtain a conversion coefficient for converting the amount of exposure to the amount of toner consumption.

This interpolation calculation process is performed based on monotonic characteristics and saturation characteristics of the electrostatic development, and it is devised so that the accuracy degradation will be small when reproducing toner development characteristics.

The system control unit 190 writes the calculated conversion coefficient into the conversion lookup table (LUT) 350 with the signal 352. The conversion lookup table (LUT) 350 converts the total exposure amount data 341 of the pixel of interest output from the exposure amount adder 340 to the data indicative of the amount of toner consumption per pixel (pixel toner consumption amount data) according to the conversion coefficient (LUT data). The conversion lookup table (LUT) 350 outputs the converted pixel toner consumption amount data 351 to the toner consumption amount calculating unit 360.

The toner consumption amount calculating unit 360 cumulates the pixel toner consumption amount data 351 of the effective region excluding the blank region and the like, one after another. By changing the pixel of interest, calculating the pixel toner consumption amount data 351, and cumulating the data one after another, the amount of toner consumption of an entire page can be calculated.

According to the present invention, it is possible to calculate the amount of consumption of an image forming material with high accuracy.

The calculated amount of toner consumption is applicable to various applications. For example, it is possible to measure or determine the life of various consumable items, such as a toner cartridge, an electrophotographic process cartridge, a photosensitive drum, a photosensitive drum cleaner and a fixer cleaner, with high accuracy.

For example, the system control unit 190 can measure or determine the life of a consumable item by storing the result of the calculation of the amount of toner consumption, and referring to the stored cumulated value of the amount of toner consumption.

It is also possible that the system control unit 190 controls the timing (adjustment timing) of executing the self-adjustment sequence (FIG. 2A) that adjusts an image such as adjusting the density or tone of an image based on the stored cumulated value of the amount of toner consumption.

The system control unit 190 can also accurately detect the state of the image forming apparatus. Thereby, it is possible to make a notification regarding the timing of maintenance at an appropriate timing, and execute maintenance (adjusting operation), so that the inactive time (down time) of the image forming apparatus can be shortened.

The system control unit 190 can also make a notification regarding the timing of toner supply based on the stored cumulated value of the amount of toner consumption. Thereby, the amount of toner supplied from a toner bottle to the developing unit is controlled preciously, so that unnecessary toner supply and waste toner can be reduced.

(Variations)

In the above embodiment, the calculation of the amount of consumption of an image forming material (toner) was described taking, as an example, a single laser beam image forming apparatus in which one pixel is defined as a pixel of interest, and leaking light occurs around the pixel of interest. However, the spirit of the present invention is not limited thereto, and it is also possible to apply the present invention to, for example a photolithography apparatus in which leaking light occurs around the pixel of interest serving as a light-emitting spot, such as a multi-beam laser scanner.

The image forming apparatus described above is configured to include a memory that holds the image data of a pixel of interest and the surrounding pixels, but similar effects can be attained also by performing a calculation using digital data with software of a calculator before forming an image. The range of the partial image region (two dimensional area) formed by a single pixel of interest and the surrounding pixels is not limited to seven pixels by seven pixels, and it is possible to set the range to any range by, for example, taking the extent of the influence of leaking light into consideration based on the exposure amount profile shown in FIG. 4A.

For example, the range of the partial image region may be nine pixels including eight pixels that surround a pixel of interest, and it is also possible to set the range to nine pixels by nine pixels, or a range larger than nine pixels by nine pixels. In addition, the partial image region is not limited to a square shape, and for example, the size defined by the main scanning direction along which a laser beam is irradiated and the sub-scanning direction orthogonal to the main scanning direction can be set to, for example, three pixels by five pixels. The range of the partial image region can be determined by trading off the desired accuracy with the calculating unit resources. The weighting coefficient can be determined by setting or calculating the weighting coefficient asymmetrically in terms of the distances of the main scanning direction and the sub-scanning direction according to the relationship between the main scanning direction of laser and time, the shape of a laser spot of a flat circular shape, or the like, or setting an asymmetric LUT, so as to increase the calculating accuracy of the amount of toner consumption.

As for various image data in which dots or blank dots occur randomly even in a one dimensional area of only the main scanning direction, it is possible to obtain higher calculation accuracy of the amount of consumption of the image forming material (toner) by adding the total amount of exposure and calculating the proximity effect of leaking light.

The above-described embodiment employs the configuration in which the weighting coefficient of a region of seven pixels by seven pixels is determined based on the distance between a pixel of interest and the surrounding pixels. However, a mathematical calculation formula can be used instead of the LUT as long as the weighting coefficient can be determined by the correlation with the distance.

Similarly, as for the conversion lookup table (LUT) 350 that converts from the total amount of exposure to the amount of toner consumption, a mathematical calculation formula can be used instead of the LUT as long as the relationship between the total amount of exposure and the amount of consumption of toner in a pixel of interest can be formulated by the mathematical calculation formula.

### Other Embodiments

It should be noted that the object of the invention is attained also by supplying a storage medium in which software program code that implements the functions of the foregoing embodiment is recorded, to a system or apparatus, by loading the program code stored in the storage medium with a computer (or CPU or MPU) of the system or apparatus, and then executing the program code.

In this case, the program code per se loaded from the storage medium implements the functions of the aforementioned embodiment, and the storage medium in which the program code is stored constitutes the present invention.

Examples of storage media that can be used for supplying the program code are a flexible disk, hard disk, optical disk, magneto-optical disk, CD-ROM, CD-R, non-volatile type memory card, ROM, etc.

The functions of the foregoing embodiment are implemented by executing computer-loaded program code. Also, an operating system (OS) or the like running on the computer based on the instructions of the program code may perform all or a part of the actual processing so that the functions of the foregoing embodiment can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-134580 filed on May 21, 2007 and No. 2008-124973 filed on May 12, 2008, which are hereby incorporated by reference herein in their entirety.

What is claimed is:

1. An image forming apparatus that forms a latent image on an image carrier based on image data, the apparatus comprising:
a first calculating unit adapted to calculate an exposure amount of a pixel of interest included in a partial region configured of a plurality of pixels that constitute the image data;
a second calculating unit adapted to calculate an exposure amount of surrounding pixels that are located around the pixel of interest and constitute the partial region; and
a toner consumption amount calculating unit adapted to calculate a toner consumption amount of the pixel of interest based on the exposure amount of the pixel of interest and the exposure amount of the surrounding pixels,
wherein the second calculating unit calculates the exposure amount of the pixel of interest by weighting the image data corresponding to the surrounding pixels on a pixel-by-pixel basis.

2. The image forming apparatus according to claim 1,
wherein the toner consumption amount calculating unit includes a third calculating unit adapted to calculate a total exposure amount of the pixel of interest based on the exposure amount of the pixel of interest and the exposure amount of the surrounding pixels; and
a converting unit adapted to convert the total exposure amount to the toner consumption amount of the pixel of interest.

3. The image forming apparatus according to claim 1,
wherein the toner consumption amount calculating unit calculates a toner consumption amount of the image data based on the toner consumption amount of the pixel of interest calculated for each pixel of interest.

4. The image forming apparatus according to claim 1, further comprising a storage unit adapted to store a plurality of scan lines' worth of image data, the scan lines corresponding to a main scanning direction when forming a latent image on the image carrier,
wherein the storage unit outputs image data corresponding to the number of pixels that constitute a predetermined partial region.

5. The image forming apparatus according to claim 1, further comprising a holding unit adapted to hold weighting data that is weighted for each pixel in the partial region,
wherein the first calculating unit calculates the exposure amount of the pixel of interest based on image data of the pixel of interest and the weighting data of the pixel of interest, and
the second calculating unit calculates the exposure amount of the surrounding pixels based on image data of the surrounding pixels and the weighting data of the surrounding pixels.

6. The image forming apparatus according to claim 2,
wherein the converting unit refers to a conversion lookup table that stores a conversion coefficient for converting an exposure amount to a toner consumption amount, and converts the total exposure amount to the toner consumption amount of the pixel of interest.

7. The image forming apparatus according to claim 1,
wherein the size of the partial region is determined by the number of pixels in a main scanning direction along which a laser is irradiated and the number of pixels in a sub-scanning direction orthogonal to the main scanning direction.

8. The image forming apparatus according to claim 1, further comprising a control unit adapted to control the operation of the image forming apparatus,
wherein the control unit determines an adjustment timing of adjusting an image of the image forming apparatus based on the toner consumption amount.

9. The image forming apparatus according to claim 8,
wherein the control unit makes a notification regarding a timing of toner supply based on the toner consumption amount.
